(19) United States
(12) Patent Application Publication
(10) Pub. No.: US 2026/0255097 A1
(43) Pub. Date: Aug. 27, 2026

(54) SYSTEM FOR HOWLING PREVENTION IN EAR-WEARABLE DEVICE

(71) Applicant: Starkey Laboratories, Inc., Eden Prairie, MN (US)

(72) Inventors: Piero Iared Rivera Benois, Bad Zwischenahn (DE); Masahiro Sunohara, Minneapolis, MN (US)

(21) Appl. No.: 19/548,110

(22) Filed: Feb. 24, 2026

Related U.S. Application Data
(60) Provisional application No. 63/764,232, filed on Feb. 27, 2025.

(51) Int. Cl. H04R 1/10; G10K 11/178; H04R 25/00

(52) U.S. Cl. CPC H04R 1/1083; G10K 11/17815; H04R 25/453; G10K 2210/1081; G10K 2210/3012; G10K 2210/30232; G10K 2210/3028; H04R 2460/01

(57) ABSTRACT

An ear-wearable device includes a receiver that outputs an acoustic signal in response to a drive signal, a source device that provides a reference audio signal, and an inward facing microphone that converts in-ear acoustic sound to an error signal. The device includes an active noise controller that provides a noise control signal based on the error signal and a processing block that provides an amplified hearing signal based on the reference audio signal. The device includes an instability detector configured to: determine a transform function that represents an approximation of an inverse of the active noise controller; apply the transform function to the drive signal to determine an inverse filter signal; apply a filter to the error signal. The filter compensates for deficiencies in the transform function. The active noise controller is disabled when an anomalous similarity between filtered error signal and the inverse filter signal is detected.

This application claims the benefit of U.S. Provisional Application No. 63/764,232, filed Feb. 27, 2025, the disclosure of which is incorporated by reference herein in its entirety.

### SUMMARY

This application relates generally to ear-level electronic systems and devices, including hearing aids, personal amplification devices, and hearables. For example, an apparatus and method facilitate active sound control with real-time howling prevention. In one embodiment an ear-wearable device includes a receiver that outputs an acoustic signal in response to a drive signal, a source device that provides a reference audio signal, and an inward facing microphone that converts in-ear acoustic sound to an error signal. The device includes an active noise controller that provides a noise control signal based on the error signal and a processing block that provides an amplified hearing signal based on the reference audio signal. The device includes an instability detector configured to: determine a transform function that represents an approximation of an inverse of the active noise controller; apply the transform function to the drive signal to determine an inverse filter signal; apply a filter to the error signal. The filter compensates for deficiencies in the transform function. The active noise controller is disabled when an anomalous similarity between filtered error signal and the inverse filter signal is detected.

In another embodiment, a method of howling prevention in an ear-wearable device involves receiving an error signal from an inward facing microphone of the ear-wearable device. Via an active noise controller W_b, a noise control signal is provided based on the error signal. Via a processing block, an amplified hearing signal is provided based on a reference audio signal from a source device. The noise control signal and the amplified hearing signal are combined to form a drive signal used to drive a receiver that outputs an acoustic signal in response thereto. The method further involves determining a transform function K that represents an approximation of an inverse of the active noise controller W_b. The transform function K is applied to the drive signal to determine an inverse filter signal, and a filter Q to is applied the error signal to produce a filtered error signal. The filter Q compensates for deficiencies in the transform function K. The active noise controller W_b is disabled when an anomalous similarity is detected between the filtered error signal and the inverse filter signal.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The discussion below makes reference to the following figures.

FIG. 1 is an illustration of a hearing device according to an example embodiment;

FIGS. 2, 3, and 4 are block diagrams of howling detection and prevention circuits according to example embodiments;

FIG. 5 is a flowchart of a method according to an example embodiment; and

FIG. 6 is a block diagram of a hearing device according to an example embodiment.

FIG. 7 is a block diagram that depicts one example of a sound processing circuit that includes multiple instability detectors.

FIG. 8 is a block diagram that depicts example implementations of the first instability detector and the second instability detector of FIG. 7.

FIG. 9 is a block diagram that depicts an exemplary sound processing circuit with an instability detector that includes a false alarm module.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” and “ear-wearable devices”), such as hearables (e.g., wearable earphones, ear monitors, and earbuds), hearing aids, hearing instruments, and hearing assistance devices, typically include an enclosure, such as a housing or shell, within which internal components are disposed.

In recent years, hearing devices and hearables have included increasingly sophisticated sound processing abilities. This is enabled at least in part by low-cost, low-power digital signal processing (DSP) chipsets which can process sound in real-time or near-real-time while performing complex calculations to enhance the sound. Some of these sound enhancements include noise reduction, echo cancellation, feedback suppression, etc. For devices such as hearing aids where the output signals may be subject to significant gain, feedback may be a significant issue to overcome. This is because, among other things, the characteristic howling sound associated with feedback is unpleasant and can reach high volume.

Howling is the well-known loud feedback sound that is heard, for example, when someone on a stage moves the microphone too close to the loudspeaker of the public address (PA) system. The sound engineer responsible for the PA system could control the howling by lowering the amplification gain provided by the PA system. In the case of ear wearable devices, howling happens when unexpected changes occur in the receiver-to-microphone transfer function. Howling might happen more often with ear wearable devices of patients with a more severe hearing loss, due to the high gain that is used to compensate for their insensitivity to certain frequencies. Howling is also an issue where active sound control is used.

Active sound control is a technology that aims at optimizing the sound field inside the ear canal by generating additional sound waves through the receiver of the ear wearable device. These additional sound waves are optimized to destructively overlap with undesired sounds and reconstruct or amplify desired sounds. Generally, an inward-facing microphone is placed at the tip of the receiver to sense the resulting sound field inside the ear canal. Because the receiver and the inward-facing microphone are close to each other, a howling prevention algorithm is used to prevent howling from occurring. One well-known active sound control algorithm is active noise cancellation, which aims at cancelling the sounds that leak into the ear canal through the earbud. Active noise cancellation operates by transmitting an inverse of the noise to be canceled (sometimes referred to as “anti-noise”) via the loudspeaker/receiver, where it destructively cancels the noise.

Feedback active noise control relies on increasing the feedback gain to enhance noise cancellation performance. However, higher feedback gain increases the risk of howling. To mitigate this, the gain controller is carefully designed to prevent howling under normal operating conditions. Nevertheless, if the transfer function from the receiver to the microphone deviates significantly from the expected model, the system may become unstable and howl. Such deviations can occur due to changes in the position of the acoustic device in the ear canal, the accumulation of earwax in the sound outlet, or other environmental factors affecting a feedback path. The present disclosure focuses on systems and devices capable of detecting such deviations that could lead to instability, enabling proactive adjustments to maintain stable operation.

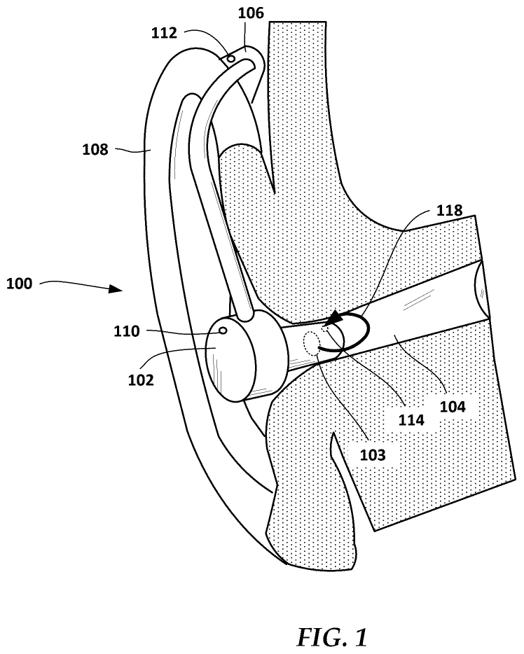

In FIG. 1, a diagram illustrates an example of an ear-wearable device 100 according to an example embodiment. The ear-wearable device 100 includes an in-ear portion 102 that fits into the ear canal 104 of a user/wearer. The ear-wearable device 100 may also include an external portion 106, e.g., worn over the back of the outer ear 108. The external portion 106 is electrically and/or acoustically coupled to the internal portion 102. The in-ear portion 102 may include an acoustic transducer 103, although in some embodiments the acoustic transducer may be in the external portion 106, where it is acoustically coupled to the ear canal 104, e.g., via a tube. The acoustic transducer 103 may be referred to herein as a “receiver,” “loudspeaker,” etc., however could include a bone conduction transducer. One or both portions 102, 106 may include an external microphone, as indicated by respective microphones 110, 112, also referred to herein as ‘source devices’ in that they are a source of audio information rendered by the device 100.

The device 100 may also include an internal microphone 114 that detects sound inside the ear canal 104. The internal microphone 114 may also be referred to as an inward-facing microphone or error microphone. For purposes of the following discussion, path 118 represents a secondary path, which is the physical propagation path from receiver 103 to the error microphone 114 within the ear canal 104.

Other components of hearing device 100 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing device 100 can incorporate a long-range communication device, such as a Bluetooth® transceiver or other type of radio frequency (RF) transceiver.

While FIG. 1 shows one example of a hearing device, often referred to as a hearing aid (HA), the term hearing device of the present disclosure may refer to a wide variety of ear-level electronic devices that can aid a person with or without impaired hearing. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a single left ear device or a single right ear device. Further, references to “hearing devices” or “ear-wearable devices” refer to two or more ear devices comprising any number of left and/or right ear devices. Further, throughout this disclosure, reference is made to a “pair of hearing devices” or a “pair of ear-wearable devices,” which is understood to refer to a system comprising a combination of a left ear device and a right ear device.

Hearing devices often integrate both an external microphone, a receiver (or other acoustic transducer) and an additional inward-facing microphone in the ear canal. The internal microphone can be used for, among other uses, active sound control (ASC). As noted above, ASC can increase the risk of feedback-induced howling. In various embodiments, the hearing device 100 is configured to turn off the ASC controller (also referred to herein as an active noise controller) when howling occurs and automatically attempts to turn it on again when no howling is present. One existing algorithm detects howling by monitoring when the receiver-to-inward-facing-microphone transfer function of the secondary path 118 equals the inverse of the active noise controller.

Unfortunately, this monitoring strategy requires a model of the inverse of the controller, which can only be approximated by using expert knowledge to address causality, stability and numerical considerations. The embodiments described herein avoid the need for a model of the inverse of the controller by processing the inward-facing microphone signal with an additional filter. Moreover, the embodiments consider specific changes in the control structure used to implement active sound control, so that an analytical solution for choosing the optimal filter parameters can be found without minimal sacrifice to active sound control. Hence, optimal howling prevention performance can be achieved without sacrificing active sound control performance.

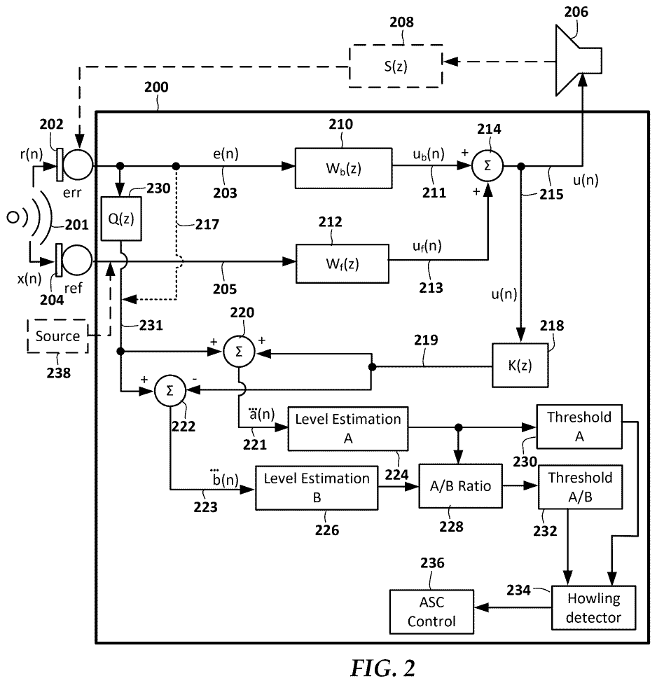

An ear-wearable device according to example embodiments turns off the active sound control algorithm when howling occurs and automatically attempts to turn it on when no howling is present. In FIG. 2, a block diagram illustrates a sound processing circuit 200 according to an example embodiment. The circuit 200 can include a digital signal processing (DSP) which is configured via software to perform the indicated functions, as well as other circuitry operable to electrically couple the circuit 200 to other components, such as an inward-facing, error microphone 202, an outward-facing, reference microphone 204, and a receiver 206.

The microphones 202, 204 receive inputs from a sound field 201, which provide respective error signal 203 and reference audio signal 205. Due to the different placements of the microphones 202, 204, their respective signals 203, 205 will be significantly different. This figure illustrates a secondary path 208 between the receiver 206 and error microphone 202. The secondary path 208 is drawn with dashed lines to indicate it is an acoustic path as opposed to the signal processing paths drawn in solid line. The secondary path is represented by a receiver-to-microphone transfer function S(z). While not shown, there is a feedback path between the receiver 206 and the error microphone 202 which can induce howling under some conditions.

An active noise controller 210 applies a function W_{b}(z) to the error signal 203 to provide a noise control signal u_{b}(n) 211. A gain filter 212 applies a function W_{f}(z) to the reference signal to produce an amplified hearing signal 213 u_{f}(n). Note that the active noise controller 210 and gain filter 212 may be referred to interchangeably by their respective functions W_{b}(z), W_{f}(z) herein.

In some embodiments, a generic processing block may provide the amplified hearing signal 213 instead of the gain filter 212. For example, devices that do not correct for hearing pathologies may still use a processing block to provide some tailoring of sound, such as equalization, enhancement, and the like. An example of such an alternative device includes a digital-to-analog converter that converts a bitstream (e.g., audio data file) to an analog signal. Such signals may be amplified to provide sufficient drive current for the receiver 206, however they do not necessarily provide an increase in sound pressure level to compensate for hearing loss or the like.

The amplified hearing signal 213 and the noise control signal 211 are combined at block 214 to provide a drive signal u(n) 215. The drive signal 215 drives the receiver 206 to produce an acoustic output. The drive signal 215 is also used by a howling detection function as described below, together with the error signal 203. The circuitry 200 may contain other sound processing functions that are not shown in this figure, and which are not necessary to gain an understanding of the howling detection functionality.

An existing algorithm presented in FIG. 2 is represented by dashed line 217 (which would replace block 230) and the processing blocks at the lower part of the figure. Generally, the algorithm detects howling by monitoring when the receiver-to-microphone transfer function 208 S(z) equals the inverse of the active noise controller W_{b}(z). This recognizes that the error signal 203 provided by the error microphone 202 may detect feedback components that are included in the receiver drive signal u(n) 215. The secondary path S(z) 208 and the active noise controller W_{b}(z) form a loop transfer function S(z) W_{b}(z) that, if equal to unity (S(z)W_{b}(z)=1), may cause at least one frequency component of u(n) to increase in magnitude over time, resulting in howling at the receiver 206. The inverse of the active noise controller W_{b}(z) is shown as inverse filter K(z) 218. Thus S(z)=W_{b}(z)⁻¹=K(z) is functionally equivalent to S(z) W_{b}(z)=1, which indicates an anomalous similarity between the error signal 203 and an inverse of the active noise controller's output.

The illustrated algorithm implements the monitoring by filtering the receiver drive signal u(n) with the inverse of the controller stored in the inverse filter 218 K(z), and then comparing the inverse filter output signal 219 with the inward-facing microphone error signal 203 e(n) to determine an anomalous similarity between the error signal 203 and the inverse filter output signal 219. In a particular embodiment, the comparison of both signals 203, 219 uses the result of the addition of the signals at block 220, resulting in a first monitoring signal 221 [symbol] (n), and the result of the subtraction of the signals at block 222, resulting in a second monitoring signal 223 [symbol] (n). The level of both signals is recursively calculated at blocks 224, 226 over time by using the following general recursive rules:

$${level}_{a …} ( n ) = β \cdot {level}_{a …} ( n - 1 ) + ( 1 - β ) \cdot a … ( n ) \cdot a … ( n )$$

$${level}_{b …} ( n ) = β \cdot {level}_{b …} ( n - 1 ) + ( 1 - β ) \cdot b … ( n ) \cdot b … ( n ) .$$

The resulting level estimates are used for the calculation of the A/B Ratio at block 228 by following the division rule:

$${ratio}_{{a}^{…} / {b}^{…}} ( n ) = \frac{{level}_{a …} ( n )}{{level}_{b …} ( n )} .$$

Thresholds for the estimated level [symbol] (n) and ratio [symbol] are determined at blocks 230 and 232 and used to detect when the receiver-to-microphone transfer function S(z) equals the inverse K(z) of the controller W_{b}(z), e.g., at howling detection block 234 (also referred to herein as an instability detector). Detection of howling at block 234 is used by ASC control block 236 to temporarily disable active noise control.

As described below, the existing algorithms (where path 217 is used) require S(z) to be equal (or as near as possible to) to the inverse K(z), which may not be easily achievable, as explained below. Instead, the embodiments described below relax that requirement, such that the howling detection block 230 can determine an anomalous similarity between the error signal 203 and the inverse filter signal 219 without the filter K(z) capturing all aspects of an inversion of the active noise controller W_{f}(z).

Aiming at determining what is the influence of each one of the elements of the systems on the monitoring signals [symbol] (n) and [symbol] (n), we assume a coherent external sound field 201 impinging on the outward-facing microphone 204 and on the inward-facing microphone 202 of the hearing device. The outward-facing microphone signal x(n) is used by the gain filter W_{f}(z) to calculate the amplified hearing aid signal u_{f}(n). Note that in some embodiments, a source device 238 different than the outward-facing microphone 204 can be used to provide the reference signal 205. For example, an audio stream from a telephone or music player may be provided from the source device 238 with or without the outward-facing microphone 204 being provided or used. In the former case, the microphone signal and other audio stream may be combined to form the reference audio signal x(n) 205. For purposes of this disclosure, the term “source device” may refer to one or both of the outward-facing microphone 204 and source device 238, and functional properties/configurations of the outward-facing microphone 204 described herein may also be applicable to the source device.

The inward-facing microphone signal r(n) is used by the controller W_{b}(z) to calculate the control signal u_{b}(n). The amplified hearing aid signal u_{f}(n) and the control signal u_{b}(n) are added together at block 214 to calculate the receiver signal u(n). Given this block diagram and the assumed coherent external sound field 201, the first monitoring signal [symbol] (n) and the A/B Ratio are given as a function of the outward-facing microphone signal x(n) by the following transfer functions in the Z-domain (the argument z is omitted, so assume K=K(z), for example):

$$\frac{A …}{X} = \frac{P \cdot ( 1 + K \cdot {W}_{b} ) + {W}_{f} \cdot ( S + K )}{1 - S \cdot {W}_{b}}$$

$$and$$

$$\frac{A …}{B …} = \frac{P \cdot ( 1 + K \cdot {W}_{b} ) + {W}_{f} \cdot ( S + K )}{P \cdot ( 1 - K \cdot {W}_{b} ) + {W}_{f} \cdot ( S - K )} ,$$

where P (z) is defined as relative transfer function between the outward-facing microphone signal and the inward-facing microphone signal relative to the sound field and equal to R(z)/X(z). If we assume that K(z) can perfectly represent the inverse of the controller W_{b}(z), then the previous equations result in the following equations:

$$\frac{{A}^{...}}{X} = \frac{P \cdot 2 + {W}_{f} \cdot ( S + {W}_{b}^{- 1} )}{1 - S \cdot {W}_{b}}$$

$$and$$

$$\frac{{A}^{...}}{{B}^{...}} = \frac{P \cdot 2 + {W}_{f} \cdot ( S + {W}_{b}^{- 1} )}{{W}_{f} \cdot ( S - {W}_{b}^{- 1} )} .$$

When S(z) equals the inverse of the controller W_{b}(z), the denominator 1−S. W_{b} of the transfer function [symbol] is zero and, therefore, the estimated level of [symbol] (n) is theoretically infinite. When inspecting the A/B Ratio under the same circumstances something equivalent is observed. When S(z) equals the inverse of the controller W_{b}(z) the denominator W_{b}·(S−W_{b}⁻¹) of the transfer function [symbol] is zero and, therefore, the estimated A/B Ratio is also theoretically infinite. All in all, if K(z) can perfectly represent the inverse of the controller W_{b}(z), both level [symbol] (n) and ratio [symbol] (n) will surpass the detection thresholds when howling occurs.

In general, the inverse filter K(z) can only approximate the inverse of the controller W_{b}(z) due to causality, stability and numerical considerations. For instance, if the controller W_{b}(z) has a delay, its inverse filter K(z) is a non-causal system. If the controller W_{b}(z) has a zero outside the unit circle in the Z-domain, its inverse filter K(z) is an unstable system. And if the controller W_{b}(z) has a gain roll-off for the low and/or high frequencies, then K(z) has a frequency response that will significantly amplify those frequencies and potentially lead to numerical issues in the DSP implementation.

In order to address these issues, the connection path represented by line 217 in FIG. 2 is replaced by filter Q(z) 230, which filters the inward-facing microphone signal e(n) to provide a filtered error signal 231. The filter Q(z) 230 solves the causality, stability and DSP implementation problems by circumventing the need to find the inverse of the controller W_{b}(z), its design and implementation in K(z). When considering the same signal comparison method used to analyze the existing algorithm, the monitoring signal [symbol] (n) and the A/B Ratio are now given by the following transfer functions:

$$\frac{{A}^{...}}{X} = \frac{P \cdot ( Q + K \cdot {W}_{b} ) + {W}_{f} \cdot ( Q \cdot S + K )}{1 - S \cdot {W}_{b}}$$

$$and$$

$$\frac{{A}^{...}}{{B}^{...}} = \frac{P \cdot ( Q + K \cdot {W}_{b} ) + {W}_{f} \cdot ( Q \cdot S + K )}{P \cdot ( Q - K \cdot {W}_{b} ) + {W}_{f} \cdot ( Q \cdot S - K )} .$$

The additional filter Q(z) provides solutions for all the problems stated above. Regarding causality, when the controller W_{b}(z) has a delay, the same delay can be stored in Q(z), so that the optimal solution for K(z) is a causal system and can be implemented. More specifically, the inverse filter K(z) can be designed to equalize the magnitude response of W_{b}(z) and Q(z) can be chosen as the all-pass filter given by the equalized response W_{b}(z). K(z).

Regarding stability, when the controller W_{b}(z) has (at least one) hypothetically-problematic zero outside the unit circle in the Z-domain (or on the right-hand half-plane of the S-domain), the hypothetically-problematic zero can be stored in Q(z), so that the optimal solution for the inverse of the controller W_{b}(z) is a stable system and can be implemented in K(z). More specifically, the zeros of the inverse filter K(z) can be chosen as the poles of the W_{b}(z) and the zeros of Q(z) can be chosen as the zeros of W_{b}(z).

Regarding the numerical problem, when the controller W_{b}(z) magnitude response has a gain roll-off for the high and/or low frequencies, the general shape of the roll-off can be stored in Q(z), so that the optimal solution for the inverse filter K(z) is almost flat for the high and/or low frequencies.

The introduction of the additional filter Q(z) offers design solutions to all problems listed above. Most of the solutions rely on the expertise of the engineer to handle the issue as a filter design task given description of the controller W_{b}(z) with explicit information about its poles, zeros and delay. Unfortunately, during the fitting process of a hearing aid in the clinic or during the automatic individualization of an over-the-counter hearing aid, there may not be enough time to get this task done. Moreover, if the controller W_{b}(z) was designed as a finite impulse response (FIR) filter, equivalent poles, zeros and delay information are estimated before starting with the filter design task.

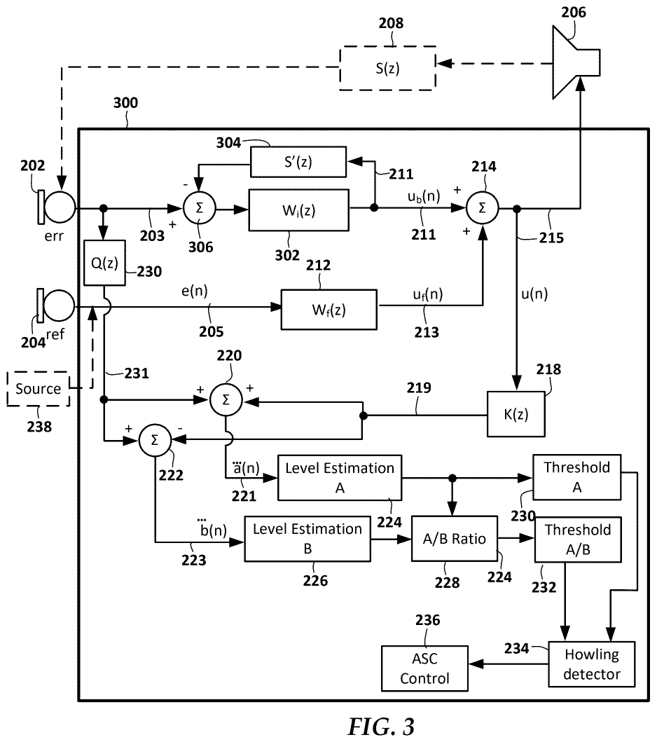

In a further refined embodiment, an analytical solution to the design of the additional filter Q(z) and inverse filter K(z) involves modifying the active sound control algorithm. The modification can be implemented as shown in the circuit 300 of FIG. 3. When modifying the active sound control algorithm, we directly replace the control filter W_{b}(z) with an alternative control filter 302 Wᵢ(z) and an estimated receiver-to-inward-facing-microphone transfer function 304 S′(z) interconnected in a negative feedback topology from noise control signal u_{b}(n) 211 to summation block 306. This topology is known in the active noise cancelling literature as the Internal Model Control approach. Equivalent active noise cancelling performance can be achieved with either control approach. Nevertheless, by leveraging the equivalence principle we used for replacing the control filter W_{b}(z) by

$${W}_{b} ( z ) = \frac{{W}_{i} ( z )}{1 + {S}^{′} ( z ) \cdot {W}_{i} ( z )} ,$$

we found that the optimal inverse and additional filters are given by

$$K ( z ) = 1 + {S}^{′} ( z ) \cdot {W}_{i} ( z )$$

$$and$$

$$Q ( z ) = {W}_{i} ( z ) .$$

Hence, the optimal additional filter Q(z) and inverse filter K(z) can be directly computed from the parameters of the active sound control algorithm and no additional lengthy optimization or filter design task must be conducted for the howling prevention algorithm. The receiver-to-inward-facing-microphone transfer function S′(z) 304 is measured via a fairly straightforward process of playing a sound (e.g., calibration tones) through the receiver while the device is in the user's ear and measuring response at the inward-facing microphone.

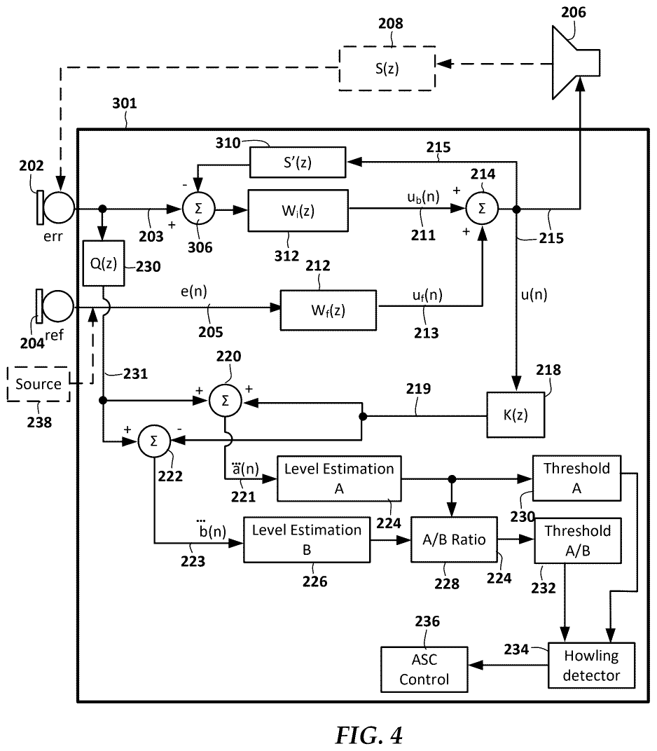

In FIG. 4, a diagram shows an alternate embodiment of the circuit shown in FIG. 3. The circuit 301 in FIG. 4 still utilizes a receiver-to-inward-facing-microphone transfer function 310 S′(z), however the input to the transfer function 310 is the drive signal u(n) 215 and not the noise control signal u_{b}(n) 211. Because this change in the transfer function will change the configuration of the alternative control filter Wᵢ(z), the filter is indicated by reference numeral 312 to differentiate from control filter 302 in FIG. 3.

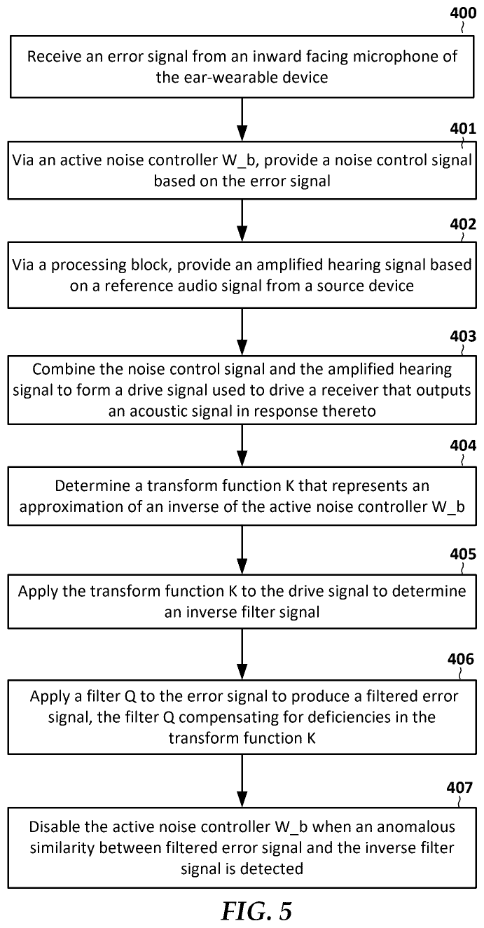

In FIG. 5, a flowchart shows a method of howling prevention in an ear-wearable device according to an example embodiment. The method involves receiving 400 an error signal from an inward facing microphone of the ear-wearable device. Via an active noise controller W_b, a noise control signal is provided 401 based on the error signal. Via a processing block, an amplified hearing signal is provided 402 based on a reference audio signal from a source device. The reference audio signal may be from an external-facing microphone and/or a digital component (e.g., memory buffer, input/output bus) that provides a digital stream from a communication signal (e.g., cellular phone audio) or a data file (e.g., music playback). The noise control signal and the amplified hearing signal are combined 403 to form a drive signal used to drive a receiver that outputs an acoustic signal in response thereto.

A transform function K is determined 404 that represents an approximation of an inverse of the active noise controller W_b. The transform function K is applied 405 to the drive signal to determine an inverse filter signal. A filter Q is applied 406 to the error signal to produce a filtered error signal. The filter Q compensates for deficiencies in the transform function K. While not shown, the method may also involve measuring a secondary path S between the receiver and the inward facing microphone (e.g., during a fitting of the device and/or while the device is in use), wherein the transform function K and the filter Q are determined based on the measured secondary path. The active noise controller W_b is disabled 407 when an anomalous similarity between filtered error signal and he inverse filter signal is detected.

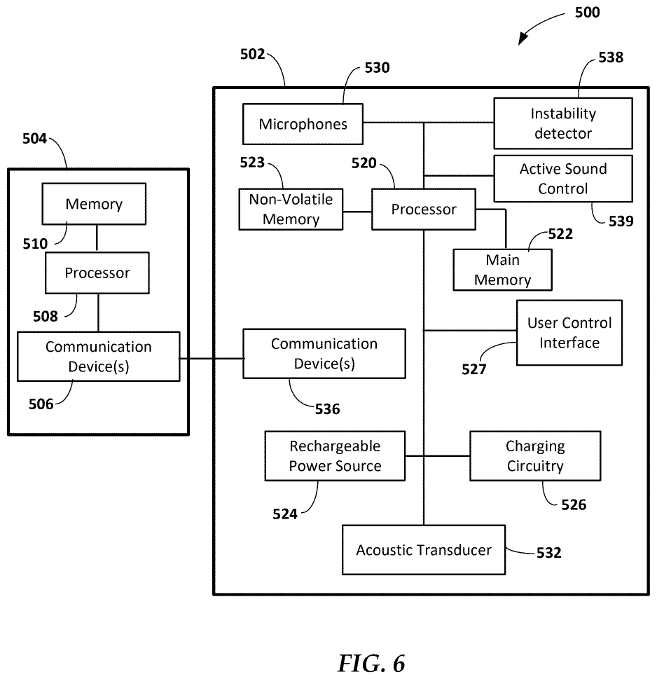

In FIG. 6, a block diagram illustrates a system and ear-worn hearing device 500 in accordance with any of the embodiments disclosed herein. The hearing device 500 includes a housing 502 configured to be worn in, on, or about an ear of a wearer. The hearing device 500 shown in FIG. 6 can represent a single hearing device configured for monaural or single-ear operation or one of a pair of hearing devices configured for binaural or dual-ear operation. The hearing device 500 shown in FIG. 6 includes a housing 502 within or on which various components are situated or supported. The housing 502 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 500 includes a processor 520 operatively coupled to a main memory 522 and a non-volatile memory 523. The processor 520 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 520 can include or be operatively coupled to main memory 522, such as RAM (e.g., DRAM, SRAM). The processor 520 can include or be operatively coupled to non-volatile (persistent) memory 523, such as ROM, EPROM, EEPROM or flash memory. As will be described in detail hereinbelow, the non-volatile memory 523 is configured to store instructions that facilitate using estimators for eardrum sound pressure based on SP measurements.

The hearing device 500 includes an audio processing facility operably coupled to, or incorporating, the processor 520. The audio processing facility includes audio signal processing circuitry (e.g., analog front-end, analog-to-digital converter, digital-to-analog converter, DSP, and various analog and digital filters), a microphone arrangement 530, and an acoustic transducer 532 (e.g., loudspeaker, receiver, bone conduction transducer). The microphone arrangement 530 can include one or more discrete microphones or a microphone array(s) (e.g., configured for microphone array beamforming). Each of the microphones of the microphone arrangement 530 can be situated at different locations of the housing 502. It is understood that the term microphone used herein can refer to a single microphone or multiple microphones unless specified otherwise.

At least one of the microphones 530 may be configured as a reference microphone producing a reference signal in response to external sound outside an ear canal of a user. Another of the microphones 1530 may be configured as an inward-facing error microphone producing an error signal in response to sound inside of the ear canal. A physical propagation path between the reference microphone and the error microphone defines a primary path of the hearing device 500. The acoustic transducer 532 produces amplified sound inside of the ear canal. The amplified sound propagates over a secondary path to combine with direct noise at the ear canal, the summation of which is sensed by the error microphone.

The hearing device 500 may also include a user interface with a user control interface 527 operatively coupled to the processor 520. The user control interface 527 is configured to receive an input from the wearer of the hearing device 500. The input from the wearer can be any type of user input, such as a touch input, a gesture input, or a voice input. The user control interface 527 may be configured to receive an input from the wearer of the hearing device 500.

The hearing device 500 also includes an instability detector 538 (also referred to as a feedback howling prevention module) operably coupled to the processor 520. The instability detector 538 can be implemented in software, hardware, or a combination of hardware and software. The instability detector 538 can be a component of, or integral to, the processor 520 or another processor coupled to the processor 520. The instability detector 538 is operable to operate as shown in blocks of FIG. 5. During operation of the hearing device 500, the instability detector 538 can be used to disable an active sound controller 539 when an anomalous similarity between a filtered error signal and a receiver drive signal filtered by an inverse of the active sound controller 539 is detected.

The hearing device 500 can include one or more communication devices 536. For example, the one or more communication devices 536 can include one or more radios coupled to one or more antenna arrangements that conform to an IEEE 802.11 (e.g., Wi-Fi®) or Bluetooth® (e.g., BLE, Bluetooth® 4.2, 5.0, 5.1, 5.2 or later) specification, for example. In addition, or alternatively, the hearing device 500 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 536 may also include wired communications, e.g., universal serial bus (USB) and the like.

The communication device 536 is operable to allow the hearing device 500 to communicate with an external computing device 504, e.g., a smartphone, laptop computer, etc. The external computing device 504 includes a communications device 506 that is compatible with the communications device 536 for point-to-point or network communications. The external computing device 504 includes its own processor 508 and memory 510, the latter which may encompass both volatile and non-volatile memory.

The hearing device 500 also includes a power source, which can be a conventional battery, a rechargeable battery (e.g., a lithium-ion battery), or a power source comprising a supercapacitor. In the embodiment shown in FIG. 6, the hearing device 500 includes a rechargeable power source 524 which is operably coupled to power management circuitry for supplying power to various components of the hearing device 500. The rechargeable power source 524 is coupled to charging circuitry 526. The charging circuitry 526 is electrically coupled to charging contacts on the housing 502 which are configured to electrically couple to corresponding charging contacts of a charging unit when the hearing device 500 is placed in the charging unit.

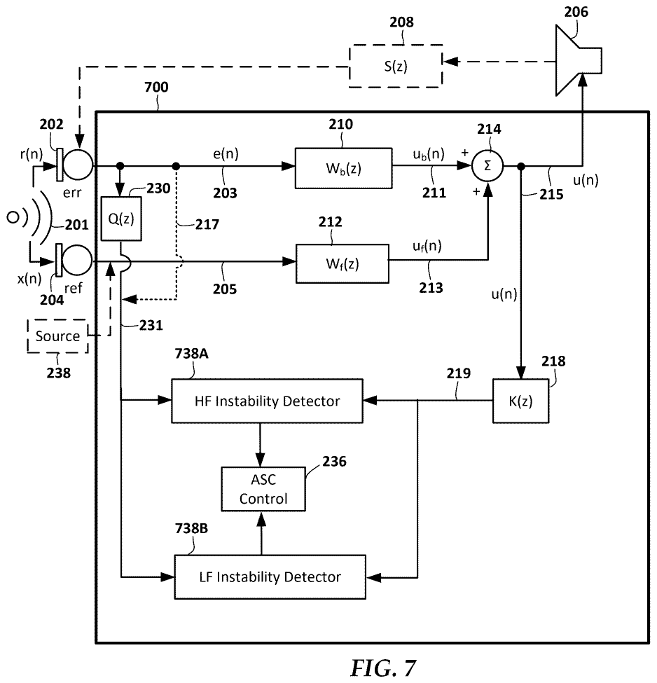

FIG. 7 is a block diagram that depicts one example of a sound processing circuit 700 that includes multiple instability detectors. Components of circuit 700 corresponding to those described above with respect to FIG. 2 are labeled with like reference numerals and operate as previously described. Accordingly, inward-facing microphone 202 produces error signal 203, source device (e.g., reference microphone 204 and/or source 238) provides reference audio signal 205, active noise controller 210 implementing W_b(z) produces noise control signal 211, processing block 212 implementing W_f(z) produces amplified hearing signal 213, and summation block 214 produces drive signal u(n) 215 that drives receiver 206. Receiver 206 is acoustically coupled to inward-facing microphone 202 through secondary path 208 represented by S(z).

As described above, drive signal 215 is provided to transform filter 218 implementing K(z), which represents an approximation of an inverse of active noise controller W_b(z), and produces inverse filter signal 219. Error signal 203 is provided to filter 230 implementing Q(z), which produces filtered error signal 231. Filter Q(z) compensates for deficiencies in K(z), including deficiencies associated with delay, non-minimum phase zeros, stability constraints, and/or magnitude roll-off of W_b(z). The filtered error signal 231 and inverse filter signal 219 are used for instability detection.

In the embodiment of FIG. 7, the instability detection function is implemented using multiple instability detectors. In particular, sound processing circuit 700 includes a first instability detector 738A and a second instability detector 738B.

The first instability detector 738A is configured to disable the active noise controller W_b when an anomalous similarity between the filtered error signal 231 and the inverse filter signal 219 is detected in a first howling frequency range. The second instability detector 738B is configured to disable the active noise controller W_b when an anomalous similarity between the filtered error signal 231 and the inverse filter signal 219 is detected in a second howling frequency range different from the first howling frequency range.

Each instability detector 738A, 738B receives the same filtered error signal 231 and the same inverse filter signal 219. However, the first and second instability detectors are configured to evaluate anomalous similarity in different frequency regions. In some embodiments, the first instability detector 738A comprises a first filter configured to block frequencies outside the first howling frequency range. The first filter may be implemented as a bandpass filter having a passband corresponding to the first howling frequency range. In other embodiments, the first instability detector 738A may comprise a highpass filter configured to block frequencies below a first cutoff frequency, such that frequencies above the cutoff frequency define the first howling frequency range.

Similarly, the second instability detector 738B may comprise a second filter configured to block frequencies outside the second howling frequency range. The second filter may be implemented as a bandpass filter having a passband corresponding to the second howling frequency range. In other embodiments, the second instability detector 738B may comprise a lowpass filter configured to block frequencies above a second cutoff frequency, such that frequencies below the cutoff frequency define the second howling frequency range.

The first and second howling frequency ranges may be non-overlapping or partially overlapping. In some embodiments, the first howling frequency range corresponds to a high-frequency range, and the second howling frequency range corresponds to a low-frequency range. The use of multiple instability detectors enables frequency-selective disabling of active noise controller 210. In some embodiments, detection by either instability detector 738A or 738B causes ASC control block 236 to disable or modify operation of W_b(z). In other embodiments, different control actions may be taken depending on whether anomalous similarity is detected in the first howling frequency range, the second howling frequency range, or both.

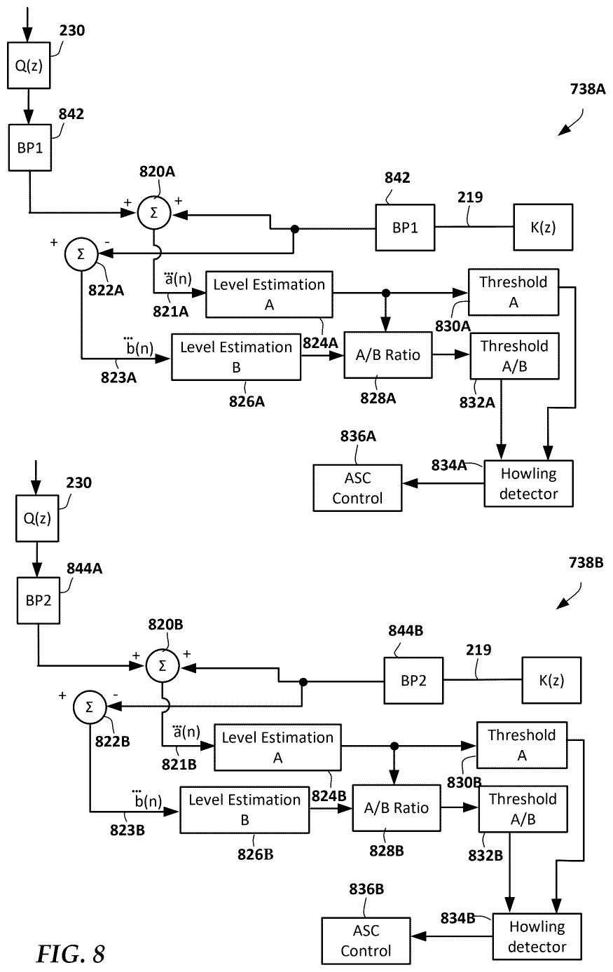

FIG. 8 is a block diagram that depicts example implementations of the first instability detector 738A and the second instability detector 738B of FIG. 7. The embodiment of FIG. 8 illustrates one manner in which each instability detector may be configured to detect anomalous similarity between the filtered error signal produced by Q(z) 230 and the inverse filter signal produced by K(z) 218 within respective frequency ranges.

With respect to the first instability detector 738A, the filtered error signal from Q(z) 230 is provided to a first filter 842 labeled F1. The inverse filter signal 219 from K (z) 218 is also provided to a corresponding filter F1 842 in the first path. The first filter F1 842 is configured to define the first howling frequency range.

In some embodiments, the first filter F1 842 is implemented as a bandpass filter configured to pass frequencies within the first howling frequency range and attenuate frequencies outside that range. In other embodiments, the first filter F1 842 is implemented as a highpass filter configured to block frequencies below a first cutoff frequency, such that frequencies above the cutoff frequency define the first howling frequency range.

The filtered error signal and inverse filter signal are combined at summation block 820A to produce a first monitoring signal 821A corresponding to a sum of the two signals within the first frequency range. The same band-limited signals are combined at summation block 822A to produce a second monitoring signal 823A corresponding to a difference between the two signals within the first frequency range.

Level estimation block 824A produces a level estimate of the first monitoring signal 821A, and level estimation block 826A produces a level estimate of the second monitoring signal 823A. An A/B ratio block 828A computes a ratio between the level estimate produced by block 824A and the level estimate produced by block 826A. Threshold block 830A compares the level estimate of the first monitoring signal 821A to a first threshold, and threshold block 832A compares the A/B ratio to a second threshold. When one or both of these thresholds are exceeded, howling detector 834A generates a detection signal indicative of anomalous similarity within the first howling frequency range. The detection signal is provided to ASC control block 836A, which is configured to disable or modify operation of active noise controller W_b(z) when howling is detected in the first frequency range.

The second instability detector 738B is structured similarly but is configured to define and monitor a second howling frequency range different from the first. The filtered error signal from Q(z) 230 is provided to a second filter 844A labeled F2, and the inverse filter signal 219 is provided to a corresponding filter 844B also labeled F2 in the second path. The second filter F2 defines the second howling frequency range.

In some embodiments, the second filter F2 is implemented as a bandpass filter configured to pass frequencies within the second howling frequency range and attenuate frequencies outside that range. In other embodiments, the second filter F2 is implemented as a lowpass filter configured to block frequencies above a second cutoff frequency, such that frequencies below the cutoff frequency define the second howling frequency range.

The band-limited signals in the second path are combined at summation block 820B to produce first monitoring signal 821B corresponding to the sum of the signals within the second frequency range, and at summation block 822B to produce second monitoring signal 823B corresponding to the difference between the signals within the second frequency range. Level estimation blocks 824B and 826B produce respective level estimates for signals 821B and 823B. A/B ratio block 828B computes a ratio between those level estimates. Threshold blocks 830B and 832B compare the level estimate and ratio to thresholds corresponding to the second frequency range. When the thresholds are exceeded, howling detector 834B generates a detection signal indicative of anomalous similarity within the second howling frequency range. The detection signal is provided to ASC control block 836B, which is configured to disable or modify operation of active noise controller W_b(z) when howling is detected in the second frequency range.

Although the structural arrangement of instability detector 738A and instability detector 738B may be similar, their parameters may differ. For example, the first filter F1 842 and the second filter F2 844A/844B may have different passbands or cutoff frequencies corresponding to the first and second howling frequency ranges. Threshold values in blocks 830A and 832A may differ from those in blocks 830B and 832B. Level estimation time constants in blocks 824A and 826A may differ from those in blocks 824B and 826B. In some embodiments, the two instability detectors may share certain computational resources or processing elements, while in other embodiments they may be implemented as separate processing modules.

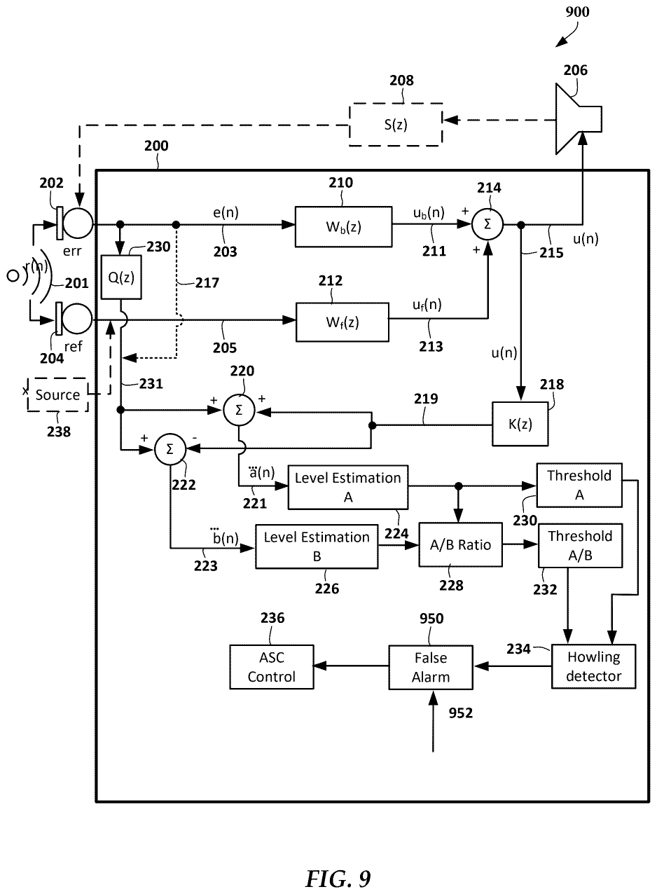

FIG. 9 is a block diagram that depicts an exemplary sound processing circuit 900 with an instability detector that includes a false alarm module. Components corresponding to those previously described with respect to FIGS. 2, 7, and 8 are labeled with like reference numerals and operate as previously described.

As in the earlier embodiments, inward-facing microphone 202 produces error signal 203, and source device (e.g., reference microphone 204 and/or source 238) provides reference audio signal 205. Active noise controller 210 implementing W_b(z) produces noise control signal 211, and processing block 212 implementing W_f(z) produces amplified hearing signal 213. Summation block 214 combines signals 211 and 213 to produce drive signal u(n) 215, which drives receiver 206. Receiver 206 is acoustically coupled to inward-facing microphone 202 via secondary path 208 represented by S(z).

Drive signal 215 is provided to transform filter 218 implementing K(z), which produces inverse filter signal 219. Error signal 203 is provided to filter 230 implementing Q (z), which produces filtered error signal 231. As described previously, K(z) approximates an inverse of W_b(z), and Q(z) compensates for deficiencies in K(z). The filtered error signal 231 and inverse filter signal 219 are combined at summation block 220 to produce first monitoring signal 221 and at summation block 222 to produce second monitoring signal 223. Level estimation blocks 224 and 226 produce respective level estimates of signals 221 and 223. A/B ratio block 228 produces a ratio between the level estimates. Threshold block 230 compares the level of signal 221 to a first threshold, and threshold block 232 compares the A/B ratio to a second threshold. When the thresholds are exceeded, howling detector 234 generates a detection signal indicative of anomalous similarity between filtered error signal 231 and inverse filter signal 219.

In the embodiment of FIG. 9, the output of howling detector 234 is not provided directly to ASC control block 236. Instead, the detection signal is provided to a false alarm module 950. The false alarm module 950 is configured to determine whether the detected anomalous similarity is likely caused by actual acoustic feedback instability or by other conditions that may produce similar signal characteristics but should not result in disabling of the active noise controller 210.

The false alarm module 950 receives the output of howling detector 234 and may also receive additional inputs 952. Inputs 952 may include motion-related signals from one or more inertial sensors integrated into the ear-wearable device, such as an inertial measurement unit (IMU), accelerometer, gyroscope, or combination thereof. For example, the accelerometer may detect periodic or impulsive motion indicative of walking, running, jumping, or head movement. The gyroscope may detect rotational motion of the head. When motion patterns consistent with device movement or user activity are detected, the false alarm module 950 may inhibit disabling of W_b(z) by ASC control block 236, thereby preventing false triggering due to motion-induced signal artifacts.

The false alarm module 950 may also analyze inputs 952 such as microphone or other sensor data to determine characteristics of the acoustic environment to determine whether detected anomalous similarity is attributable to a low-frequency noise environment rather than acoustic feedback. For example, sustained low-frequency energy in approximately the 20-50 Hz range, such as 30-40 Hz, may be indicative of automobile engine noise, train noise, airplane cabin noise, boat engine noise, or other transportation-related noise environments. Similarly, broadband low-frequency crowd noise may be present in stadiums, public transit, or large gatherings. In such environments, strong low-frequency energy may produce signal correlations that resemble howling detection metrics without true feedback instability. The false alarm module 950 may analyze spectral energy distribution, frequency content, and temporal characteristics of microphone signals or other sensor input to determine whether the environment corresponds to such low-frequency noise conditions and suppress disabling of the active noise controller accordingly.

In some embodiments, the false alarm module 950 may operate based on inputs 952 from an environmental classification subsystem configured to classify the current audio environment. The environmental classification subsystem may operate using rule-based logic, feature-based classification, or a machine learning model. In certain embodiments, the environmental classification subsystem includes a machine learning model, such as a neural network, configured to classify the audio environment based on features extracted from one or more microphone signals.

The machine learning model may be a deep neural network (DNN), convolutional neural network (CNN), recurrent neural network (RNN), or other supervised learning architecture. During training, labeled audio data corresponding to various environments (e.g., car interior, airplane cabin, train, boat, crowd, quiet indoor, office, speech-only, music playback, true feedback/howling events) may be collected. Acoustic features such as spectral coefficients, Mel-frequency cepstral coefficients (MFCCs), band energy distributions, modulation features, and temporal statistics may be extracted and provided as input to the neural network. The network parameters may be optimized using unsupervised and/or supervised learning techniques to minimize classification error across the labeled dataset. Once trained, the model may be stored in memory of the ear-wearable device and executed by the processor to classify the current audio environment in real time.

The output of the environmental classification subsystem may indicate that the device is operating in a transportation environment, a crowd environment, a speech-dominant environment, or other predefined acoustic category. Based on the classified environment, the false alarm module 950 may inhibit or modify the disable signal provided to ASC control block 236. For example, if the environment is classified as a low-frequency transportation environment, disabling of the active noise controller 210 in response to low-frequency instability detection may be suppressed. In other cases, if the environment is classified as a stable quiet environment and anomalous similarity is detected, the false alarm module 950 may allow the disable signal to pass to ASC control block 236.

The false alarm module 950 may operate in conjunction with one or more instability detectors, including the frequency-selective instability detectors described with respect to FIGS. 7 and 8. In some embodiments, a common false alarm module may evaluate detection outputs from multiple instability detectors. In other embodiments, separate false alarm logic may be associated with different instability detectors. For example, suppression based on detection of low-frequency transportation noise may be applied primarily to a low-frequency instability detector, while a high-frequency instability detector may remain active. Thus, false alarm mitigation may be implemented globally or on a frequency-selective basis.

This disclosure includes without limitation the following Clauses:

Clause 1. An ear-wearable device, comprising: a receiver that outputs an acoustic signal in response to a drive signal; a source device that provides a reference audio signal; an inward facing microphone that converts in-ear acoustic sound to an error signal; and a processing element comprising: an active noise controller W_b that provides a noise control signal based on the error signal; a processing block that provides an amplified hearing signal based on the reference audio signal, the noise control signal and the amplified hearing signal being combined to form the drive signal; and an instability detector configured to: determine a transform function K that represents an approximation of an inverse of the active noise controller W_b; apply the transform function K to the drive signal to determine an inverse filter signal; apply a filter Q to the error signal, the filter Q compensating for deficiencies in the transform function K; and disable the active noise controller W_b when an anomalous similarity between the filtered error signal and the inverse filter signal is detected.

Clause 2. The ear-wearable device of Clause 1, wherein the source device comprises an outward-facing microphone that converts out-of-ear acoustic sounds to the reference audio signal.

Clause 3. The ear-wearable device of any one of Clauses 1-2, wherein the source device provides a digital stream from a communication signal or a data file, the digital stream used to form the reference signal.

Clause 4. The ear-wearable device of any one of Clauses 1-3, wherein the anomalous similarity between the filtered error signal and the inverse filter signal is indicative of an onset of feedback between the receiver and the inward facing microphone.

Clause 5. The ear-wearable device of any one of Clauses 1-4, wherein the transform function K and the filter Q are determined based on a measured secondary path S between the receiver and the inward facing microphone.

Clause 6. The ear-wearable device of any one of Clauses 1-5, wherein the processing block comprises a gain filter W_f applied to the reference signal to provide the amplified hearing signal.

Clause 7. The ear-wearable device of any one of Clauses 1-6, wherein the anomalous similarity is determined based on a first monitoring signal exceeding a first threshold, the first monitoring signal comprising a sum of the filtered error signal and the inverse filter signal.

Clause 8. The ear-wearable device of clause 7, wherein the anomalous similarity is determined further based on a ratio between the first monitoring signal and a second monitoring signal exceeding a second threshold, the second monitoring signal comprising a difference between the filtered error signal and the inverse filter signal.

Clause 9. The ear-wearable device of any one of Clauses 1-8, wherein the deficiency in the transform function K is due to the controller W_b having a delay, and wherein the delay is stored in the filter Q.

Clause 10. The ear-wearable device of any one of Clauses 1-9, wherein the deficiency in the transform function K is due to the active noise controller W_b having a zero outside a unit circle in a Z-domain or on a right-hand half-plane of an S-domain, and wherein the zero is stored in the filter Q.

Clause 11. The ear-wearable device of any one of Clauses 1-10, wherein the deficiency in the transform function K is due to the controller W_b having a magnitude response with one or both of high frequency gain roll-off and low frequency gain roll-off, and wherein one or both of the high frequency gain roll-off and the low frequency gain roll-off are stored in the filter Q.

Clause 12. The ear-wearable device of any one of Clauses 1-11, the filter Q is determined based on modifying an active sound control algorithm of W_b using internal model control.

Clause 13. The ear-wearable device of Clause 12, wherein modifying the active sound control algorithm determining an alternative control filter W_i and an estimated receiver-to-inward-facing-microphone transfer function S′ interconnected in a negative feedback topology, wherein Q is equivalent to W_i and K is equivalent to 1+S′SYMBOLW_i in a transform domain.

Clause 14. The ear-wearable device of any one of Clauses 1-13, wherein the processing element is further configured to turn on the active noise controller W_b when the anomalous similarity between the filtered error signal and the inverse filter signal is no longer detected.

Clause 15. The ear-wearable device of any one of Clauses 1-14, wherein the instability detector is a first instability detector configured to disable the active noise controller W_b when an anomalous similarity between the filtered error signal and the inverse filter signal is detected in a first howling frequency range, and further comprising: a second instability detector configured to disable the active noise controller W_b when an anomalous similarity between the filtered error signal and the inverse filter signal is detected in a second frequency howling frequency range different than the first frequency howling range.

Clause 16. The ear-wearable device of Clause 15, wherein the first instability detector comprises a first bandpass filter configured to block frequencies outside a first frequency range, and the second instability detector comprises a second bandpass filter configured to block frequencies outside a second frequency range different from the first frequency range.

Clause 17. The ear-wearable device of any one of Clauses 15-16, wherein the first instability detector comprises a highpass filter configured to block frequencies below a first cutoff frequency, and the second instability detector comprises a lowpass filter configured to block frequencies above a second cutoff frequency.

Clause 18. The ear-wearable device of any one of Clauses 15-17, wherein the first howling monitor is configured to detect an anomalous similarity in the first frequency howling range based on the same filtered error signal and the same inverse filter signal the second howling monitor uses to detect an anomalous similarity in the second frequency howling range.

Clause 19. The ear-wearable device of any one of Clauses 15-18, wherein the instability detector further comprises a false alarm monitor configured to prevent disabling of the active noise controller W_b when an anomalous similarity is detected.

Clause 20. The ear-wearable device of Clause 19, wherein the false alarm monitor is configured to prevent disabling of the active noise controller W_b responsive to one or more of: detecting the own voice of a wearer of the ear-wearable device in a microphone signal; detecting movement of the ear-wearable device; detecting a user is walking, jumping, and/or headshaking; detecting a user is in a low frequency noise environment; and an environmental classification.

Clause 21. The ear-wearable device of Clause 20, wherein the environmental classification is from a machine learning model configured to classify an audio environment based on previously processed training data

Clause 22. A method of howling prevention in an ear-wearable device, comprising: receiving an error signal from an inward facing microphone of the ear-wearable device; via an active noise controller W_b, providing a noise control signal based on the error signal; via a processing block, providing an amplified hearing signal based on a reference audio signal from a source device; combining the noise control signal and the amplified hearing signal to form a drive signal used to drive a receiver that outputs an acoustic signal in response thereto; determining a transform function K that represents an approximation of an inverse of the active noise controller W_b; applying the transform function K to the drive signal to determine an inverse filter signal; applying a filter Q to the error signal to produce a filtered error signal, the filter Q compensating for deficiencies in the transform function K; and disabling the active noise controller W_b when an anomalous similarity is detected between the filtered error signal and the inverse filter signal.

Clause 23. The method of Clause 22, wherein the source device comprises an outward-facing microphone that converts out-of-ear acoustic sounds to the reference audio signal.

Clause 24. The method of any one of Clauses 22-23, wherein the source device provides a digital stream from a communication signal or a data file, the digital stream used to form the reference signal.

Clause 25. The method of any one of Clauses 22-24, wherein the anomalous similarity between the filtered error signal and the inverse filter signal is indicative of an onset of feedback between the receiver and the inward facing microphone.

Clause 26. The method of any of one of Clauses 22-25, further comprising measuring a secondary path S between the receiver and the inward facing microphone, wherein the transform function K and the filter Q are determined based on the measured secondary path.

Clause 27. The method of any one of Clauses 22-26, wherein the processing block comprises a gain filter W_f applied to the reference signal to provide the amplified hearing signal.

Clause 28. The method of any of one of Clauses 22-27, wherein the anomalous similarity is determined based on a first monitoring signal exceeding a first threshold, the first monitoring signal comprising a sum of the filtered error signal and the inverse filter signal.

Clause 29. The method of clause 28, wherein the anomalous similarity is determined further based on a ratio between the first monitoring signal and a second monitoring signal exceeding a second threshold, the second monitoring signal comprising a difference between the filtered error signal and the inverse filter signal.

Clause 30. The method of any one of Clauses 22-29, wherein the deficiency in the transform function K is due to the controller W_b having a delay, and wherein the delay is stored in the filter Q.

Clause 31. The method of any one of Clauses 22-30, wherein the deficiency in the transform function K is due to the active noise controller W_b having a zero outside a unit circle in a Z-domain or on a right-hand half-plane of an S-domain, and wherein the zero is stored in the filter Q.

Clause 32. The method of any one of Clauses 22-31, wherein the deficiency in the transform function K is due to the controller W_b having a magnitude response with one or both of high frequency gain roll-off and low frequency gain roll-off, and wherein one or both of the high frequency gain roll-off and the low frequency gain roll-off are stored in the filter Q.

Clause 33. The method of any one of Clauses 22-32, the filter Q is determined based on modifying an active sound control algorithm of W_b using internal model control.

Clause 34. The method of Clause 33, wherein modifying the active sound control algorithm determining an alternative control filter W_i and an estimated receiver-to-inward-facing-microphone transfer function S′ interconnected in a negative feedback topology, wherein Q is equivalent to W_i and K is equivalent to 1+S′SYMBOLW_i in a transform domain.

Clause 35. The method of any one of Clauses 22-34, further comprising turning on the active noise controller W_b when the anomalous similarity between the filtered error signal and the inverse filter signal is no longer detected.

Clause 36. The method of any one of Clauses 22-35, further comprising: using a first instability detector to disable the active noise controller W_b when an anomalous similarity between the filtered error signal and the inverse filter signal is detected in a first howling frequency range; and using a second instability detector to disable the active noise controller W_b when an anomalous similarity between the filtered error signal and the inverse filter signal is detected in a second frequency howling frequency range different than the first frequency howling range.

Clause 37. The method of any one of Clauses 22-36, further comprising preventing the disabling of the active noise controller W_b when an anomalous similarity is detected based on one or more of: detecting the own voice of a wearer of the ear-wearable device in a microphone signal; detecting movement of the ear-wearable device; detecting a user is walking, jumping, and/or headshaking; detecting a user is in a low frequency noise environment; and an environmental classification.

Clause 38. A computer-readable medium that stores instructions configured to cause a computing device to: receive an error signal from an inward facing microphone of the ear-wearable device; provide a noise control signal based on the error signal; provide an amplified hearing signal based on a reference audio signal from a source device; combine the noise control signal and the amplified hearing signal to form a drive signal used to drive a receiver that outputs an acoustic signal in response thereto; determine a transform function K that represents an approximation of an inverse of the active noise controller W_b; apply the transform function K to the drive signal to determine an inverse filter signal; apply a filter Q to the error signal to produce a filtered error signal, the filter Q compensating for deficiencies in the transform function K; and disable the active noise controller W_b when an anomalous similarity is detected between the filtered error signal and the inverse filter signal.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An ear-wearable device, comprising:
a receiver that outputs an acoustic signal in response to a drive signal;
a source device that provides a reference audio signal;
an inward facing microphone that converts in-ear acoustic sound to an error signal; and
a processing element comprising:
an active noise controller W_b that provides a noise control signal based on the error signal;
a processing block that provides an amplified hearing signal based on the reference audio signal, the noise control signal and the amplified hearing signal being combined to form the drive signal; and
an instability detector configured to:
determine a transform function K that represents an approximation of an inverse of the active noise controller W_b;
apply the transform function K to the drive signal to determine an inverse filter signal;
apply a filter Q to the error signal, the filter Q compensating for deficiencies in the transform function K; and
disable the active noise controller W_b when an anomalous similarity between the filtered error signal and the inverse filter signal is detected.

2. The ear-wearable device of claim 1, wherein the source device comprises an outward-facing microphone that converts out-of-ear acoustic sounds to the reference audio signal.

3. The ear-wearable device of claim 1, wherein the source device provides a digital stream from a communication signal or a data file, the digital stream used to form the reference signal.

4. The ear-wearable device of claim 1, wherein the anomalous similarity between the filtered error signal and the inverse filter signal is indicative of an onset of feedback between the receiver and the inward facing microphone.

5. The ear-wearable device of claim 1, wherein the transform function K and the filter Q are determined based on a measured secondary path S between the receiver and the inward facing microphone.

6. The ear-wearable device of claim 1, wherein the anomalous similarity is determined based on a first monitoring signal exceeding a first threshold, the first monitoring signal comprising a sum of the filtered error signal and the inverse filter signal.

7. The ear-wearable device of claim 6, wherein the anomalous similarity is determined further based on a ratio between the first monitoring signal and a second monitoring signal exceeding a second threshold, the second monitoring signal comprising a difference between the filtered error signal and the inverse filter signal.

8. The ear-wearable device of claim 1, wherein the processing element is further configured to turn on the active noise controller W_b when the anomalous similarity between the filtered error signal and the inverse filter signal is no longer detected.

9. The ear-wearable device of claim 1, wherein the instability detector is a first instability detector configured to disable the active noise controller W_b when an anomalous similarity between the filtered error signal and the inverse filter signal is detected in a first howling frequency range, and further comprising:
a second instability detector configured to disable the active noise controller W_b when an anomalous similarity between the filtered error signal and the inverse filter signal is detected in a second frequency howling frequency range different than the first frequency howling range.

10. The ear-wearable device of claim 1, further comprising a false alarm monitor configured to prevent disabling of the active noise controller W_b when an anomalous similarity is detected responsive to one or more of:
detecting the own voice of a wearer of the ear-wearable device in a microphone signal;
detecting movement of the ear-wearable device;
detecting a user is walking, jumping, and/or headshaking;
detecting a user is in a low frequency noise environment; and
an environmental classification.

11. A method of howling prevention in an ear-wearable device, comprising:
receiving an error signal from an inward facing microphone of the ear-wearable device;
via an active noise controller W_b, providing a noise control signal based on the error signal;
via a processing block, providing an amplified hearing signal based on a reference audio signal from a source device;
combining the noise control signal and the amplified hearing signal to form a drive signal used to drive a receiver that outputs an acoustic signal in response thereto;
determining a transform function K that represents an approximation of an inverse of the active noise controller W_b;
applying the transform function K to the drive signal to determine an inverse filter signal;
applying a filter Q to the error signal to produce a filtered error signal, the filter Q compensating for deficiencies in the transform function K; and
disabling the active noise controller W_b when an anomalous similarity is detected between the filtered error signal and the inverse filter signal.

12. The method of claim 11, wherein the source device comprises an outward-facing microphone that converts out-of-ear acoustic sounds to the reference audio signal.

13. The method of claim 11, wherein the source device provides a digital stream from a communication signal or a data file, the digital stream used to form the reference signal.

14. The method of claim 11, wherein the anomalous similarity between the filtered error signal and the inverse filter signal is indicative of an onset of feedback between the receiver and the inward facing microphone.

15. The method of claim 11, wherein the anomalous similarity is determined based on a first monitoring signal exceeding a first threshold, the first monitoring signal comprising a sum of the filtered error signal and the inverse filter signal.

16. The method of claim 15, wherein the anomalous similarity is determined further based on a ratio between the first monitoring signal and a second monitoring signal exceeding a second threshold, the second monitoring signal comprising a difference between the filtered error signal and the inverse filter signal.

17. The method of claim 22, further comprising turning on the active noise controller W_b when the anomalous similarity between the filtered error signal and the inverse filter signal is no longer detected.

18. The method of claim 22, further comprising:
using a first instability detector to disable the active noise controller W_b when an anomalous similarity between the filtered error signal and the inverse filter signal is detected in a first howling frequency range; and
using a second instability detector to disable the active noise controller W_b when an anomalous similarity between the filtered error signal and the inverse filter signal is detected in a second frequency howling frequency range different than the first frequency howling range.

19. The method of claim 22, further comprising preventing the disabling of the active noise controller W_b when an anomalous similarity is detected based on one or more of:
detecting the own voice of a wearer of the ear-wearable device in a microphone signal;
detecting movement of the ear-wearable device;
detecting a user is walking, jumping, and/or headshaking;
detecting a user is in a low frequency noise environment; and
an environmental classification.

20. A computer-readable medium that stores instructions configured to cause a computing device to:
receive an error signal from an inward facing microphone of an ear-wearable device;
via an active noise controller W_b, provide a noise control signal based on the error signal;
via a processing block, provide an amplified hearing signal based on a reference audio signal from a source device;
combine the noise control signal and the amplified hearing signal to form a drive signal used to drive a receiver that outputs an acoustic signal in response thereto;
determine a transform function K that represents an approximation of an inverse of the active noise controller W_b;
apply the transform function K to the drive signal to determine an inverse filter signal;
apply a filter Q to the error signal to produce a filtered error signal, the filter Q compensating for deficiencies in the transform function K; and
disable the active noise controller W_b when an anomalous similarity is detected between the filtered error signal and the inverse filter signal.
